(19) United States
(12) Patent Application Publication
(10) Pub. No.: US 2007/0164472 A1
(43) Pub. Date: Jul. 19, 2007

(54) Method and apparatus for producing a hollow body

(76) Inventors: Thomas Endig, Fellbach-Oeffingen (DE); Volker Brielmann, Madrid (ES); Bernd Beiermeister, Steinheim-Kleinbottwar (DE); Joerg Hielscher, Winterbach (DE); Alexander Ziegler, Esslingen (DE); Olof Hansen, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/587,010

(22) PCT Filed: Apr. 5, 2005
(86) PCT No.: PCT/EP05/51510

§ 371 Date: Oct. 20, 2006

(30) Foreign Application Priority Data
Apr. 20, 2004 (DE) 10 2004 018936.6

(51) Int. Cl. B29C 65/70; B29C 45/00

(52) U.S. Cl. 264/248; 425/517; 425/518

(57) ABSTRACT

A method of and an apparatus for producing a hollow body of thermoplastic includes the steps of injection molding a first hollow body part with an outward-protruding first joining edge, injection molding at least a second hollow body part with an outward-protruding second joining edge, putting the hollow body parts together at the first and second joining edges, and connecting the first and the at least one second hollow body part by a molded, at least partially U-shaped sealing portion comprising a thermoplastic.

### PRIOR ART

The invention relates to a method and an apparatus for producing a hollow body of thermoplastic, in particular with at least one component inserted into it. The invention also relates to a hollow body of thermoplastic having at least two injection molded, put-together hollow body parts and at least one component disposed in the hollow body parts.

Hollow bodies of thermoplastic are used for instance as housings for valves, sensors, or electronic control units. At present, the hollow bodies are often produced as follows: In a first production step, at least two hollow body parts, for instance in the form of housing components or housing halves, are injection molded. After that, in a second production step, components, for instance in the form of inlay parts, are mounted or inlaid in or otherwise inserted into the hollow body parts. Finally, in a further production step, the at least two hollow body parts are connected by a suitable joining method. Examples of joining methods used for this are various material-engagement welding processes, such as ultrasonic, laser, or friction welding, as well as positive-engagement connections, such as detent locking or screw fastening.

For such joining methods, additional sealing components are as a rule needed. Moreover, such production methods must be done by means of especially adapted, additional production equipment, which not least means the associated production apparatus requires a comparatively large amount of space.

### OBJECT AND SUMMARY OF THE INVENTION

The object of the invention is to create a method and an apparatus for producing a hollow body of thermoplastic that entail comparatively low production costs and require substantially less space than conventional production processes.

The object is attained according to the invention with a method for producing a hollow body of thermoplastic, which includes the following steps: injection molding a first hollow body part with an outward-protruding first joining edge; injection molding at least a second hollow body part with an outward-protruding second joining edge; putting the hollow body parts together at the first and second joining edges; and connecting the first and the at least one second hollow body part by spray-coating the two joining edges or by injection molding a sealing portion that encompasses the joining edges essentially in U-shaped fashion. The object is also attained with an apparatus for producing a hollow body of thermoplastic with at least one component inserted into it, which includes a first injection molding device, integrated with the apparatus, for injection molding at least two hollow body parts; a mounting device, integrated with the apparatus, for mounting the at least one component in at least one of the hollow body parts and for putting the hollow body parts together at joining edges; and a second injection molding device, integrated with the apparatus, for connecting the hollow body parts by injection molding of a thermoplastic at the joining edges. Finally, the object is attained by a hollow body of thermoplastic, which has at least two injection molded, put-together hollow body parts, on each of which an outward-oriented or outward-protruding joining edge is embodied; and which are held together with an injection molded sealing portion which is embodied as at least partly U-shaped, embracing the joining edges at the hollow body parts.

According to the invention, it is proposed that a hollow body be formed by means of two hollow body parts, which are provided with joining edges and are connected by an injection molded sealing portion surrounding the joining edges. A sealing portion of this kind is especially economical to make in terms of manufacturing tools, and at the same time it forms a durable tight connection between the hollow body parts. The spray-coating of the sealing portion can be very well combined with the other manufacturing steps according to the invention, leading overall to economical, space-saving manufacture of the hollow body of the invention. Thus an injection molding work step, a mounting process, and a sealing spray-coating process are integrated into an apparatus of the invention. As a result of this integration and combination according to the invention of various manufacturing steps, and because of the intentional provision of an injection molded sealing portion on likewise injection molded, put-together hollow body parts, the associated manufacturing costs can be reduced considerably, and the complete production and assembly of the hollow body parts can moreover be accomplished in a way that requires little space. Furthermore, joining methods of the kind described at the outset for connecting the at least two hollow body parts can be dispensed with according to the invention.

Work steps for mounting at least one component are advantageously integrated into the production according to the invention of the hollow body parts and in the spray-coating of the sealing portion. This work step can in particular be performed parallel to an injection molding work step, especially in a combined injection molding and mounting device. The at least one component can be laid in a suitable injection molding tool either fully automatically or manually, for instance. During this operation, one of the injection molding work steps according to the invention can simultaneously be performed, thus optimally utilizing the cycle time of the apparatus of the invention and as a result shortening the total manufacturing time required.

It is furthermore advantageous according to the invention if the injection molding of the at least two hollow body parts is performed with a first thermoplastic component and the connecting of the hollow body parts is performed by injection molding with a second thermoplastic component. The various thermoplastic components used can then be especially adapted to the peripheral conditions involved in a given injection molding work step and to the properties to be achieved for the hollow body. In particular, the second thermoplastic component can be specifically aimed at good sealing of the hollow body that has been made according to the invention.

A testing device, particularly a tightness testing device for testing the tightness of the hollow body and/or a final testing device, may be integrated with the apparatus of the invention. With this further integration of work steps in a single apparatus, assembly and handling operations that were previously done in separate devices, and that as activities that do not justify their expense have until now kept manufacturing costs higher, are dispensed with. With the combination according to the invention of injection molding, mounting and sealing spray-coating work steps in a single apparatus, a comparatively large number of work steps are already integrated, and therefore with a likewise-integrated final test, direct quality control of these work steps becomes possible. For instance, a flaw in a injection molding device can be detected without delay. The injection molding device can then be shut down immediately and appropriate maintenance or repair can be initiated.

With the apparatus of the invention two housing parts for instance can be injection molded in one tool or in separate tools, the housing parts can then be unmolded, and appropriate components can be mounted in them. In a second injection molding work step, the housing parts are tightly spray-coated together with the components. Finally, the final test is done, either in the apparatus itself or at a separate testing station.

The injection molded sealing portion, provided according to the invention, at joining edges of the put-together hollow body parts is embodied on the outside, such that the two put-together hollow body parts are partially enclosed at the joining edges by the thermoplastic introduced in the second injection molding work step. To that end, the joining edges are designed in close reliance on the specification for the hollow body to be produced and in particular are adapted to the sealing portion.

In designing the joining edges, it is especially advantageous if the hollow body parts are each provided with at least one connecting element, in particular in the form of a detent lug, by means of which a nonpositive-and/or positive-engagement connection between the put-together hollow body parts is embodied. With the nonpositive- and/or positive-engagement connection, the two hollow bodies can be coupled to one other, so that in the ensuing injection molding work step, they are securely positioned in an associated injection molding tool.

It is furthermore advantageous if the hollow body parts are each provided at the joining edges with at least one sealing element, in particular in the form of a sealing edge, by means of which the hollow body parts are sealed off from one another and/or from an injection mold during the production of the hollow body, With the sealing edges, thermoplastic is prevented from getting into the hollow body itself. This also prevents thermoplastic from migrating through the parting face between the hollow body parts and the injection mold during the second injection molding work step and for instance causing the formation of a burr.

The hollow body parts according to the invention can moreover advantageously each be provided at the joining edges with at least one connecting element, in particular in the form of fusion edges, by means of which edge or edges a material-engagement connection between the put-together hollow body parts and/or the sealing portion is embodied. The fusion edges are for instance designed such that in the second injection molding work step according to the invention, they are partially converted from the hot plastic melt into a molten state, thus bringing about the material-engagement connection between the joining edges of the hollow body parts and the spray-coated second thermoplastic component.

By the combination of the production methods described above, it is possible overall to attain a nonpositive-, positive-, and material-engagement connection can overall at the joining edges of the hollow body parts of the invention. Such a connection meets the most stringent requirements in terms of tightness and durability.

Overall, with the procedure according to the invention, a method and an apparatus are created in which injection molding tools attain two objects. The injection molding tools serve first as an injection mold and then as a mounting platform or measuring platform.

In an apparatus of the invention, for instance in a first region of the apparatus, an injection molding tool may be disposed that furnishes the mold technology for the first and second injection molding work steps, while in a second region of the apparatus, the possibility is created of laying in or mounting components and inverting and positioning the hollow body parts for the sealing spray-coating process. While then both injection molding work steps are done in one region of the apparatus (the injection molding side), in the second region mounting and inverting are done simultaneously (the service side). In this way, separate mounting devices are unnecessary, and changes and adaptations to such mounting devices can also be dispensed with, since in the invention, for new variants of hollow bodies, only the associated injection molding tools need to be adapted.

The tool concept of this kind according to the invention can be implemented especially advantageously in a turntable. Alternative concepts are also conceivable, however, for instance in the form of an injection molding tool in which the various regions are disposed linearly to one another.

In terms of the geometry of the joining edges according to the invention, it is moreover especially advantageous if the associated hollow body parts can be unmolded from the associated injection molding device by a motion in a single dimension. As already mentioned above, in the spray-coating in the second injection molding work step, the interior of the hollow body is advantageously sealed along one or more encircling press-fit edges. Alternatively or in addition, an encircling sealing edge may, as noted, be provided for sealing off the hollow body parts from the injection molding device. Such encircling sealing edges, as sealing elements, are each deformed elastically-plastically by between 0.1 mm and 0.3 mm in the closing direction in the course of the joining together of the tool halves of the injection molding device.

In summary, it can be stated that the method concept of the invention makes a joining place with a combined nonpositive-, positive-, and material-engagement connection possible, as a result of which the most stringent demands in terms of strength and tightness are met. In the apparatus of the invention, components can simultaneously be mounted without losing cycle time. The tool concept and the inversion technology according to the invention can therefore be realized very economically and with a high degree of integration.

### BRIEF DESCRIPTION OF THE DRAWINGS

One exemplary embodiment of an apparatus according to the invention for producing a thermoplastic hollow body, and an associated hollow body, are described in further detail below in conjunction with the schematic drawings. Shown are:

FIG. 1, a fragmentary sectional view and a partial top view on one exemplary embodiment of an apparatus of the invention for producing a hollow body of thermoplastic;

FIG. 2, a longitudinal section through an exemplary embodiment of a hollow body of the invention after a first injection molding work step;

FIG. 3, an enlarged view of a portion of the hollow body of FIG. 2; and

FIG. 4, the longitudinal section of FIG. 2, after a second injection molding work step.

### DETAILED DESCRIPTION OF AN EXEMPLARY EMBODIMENT

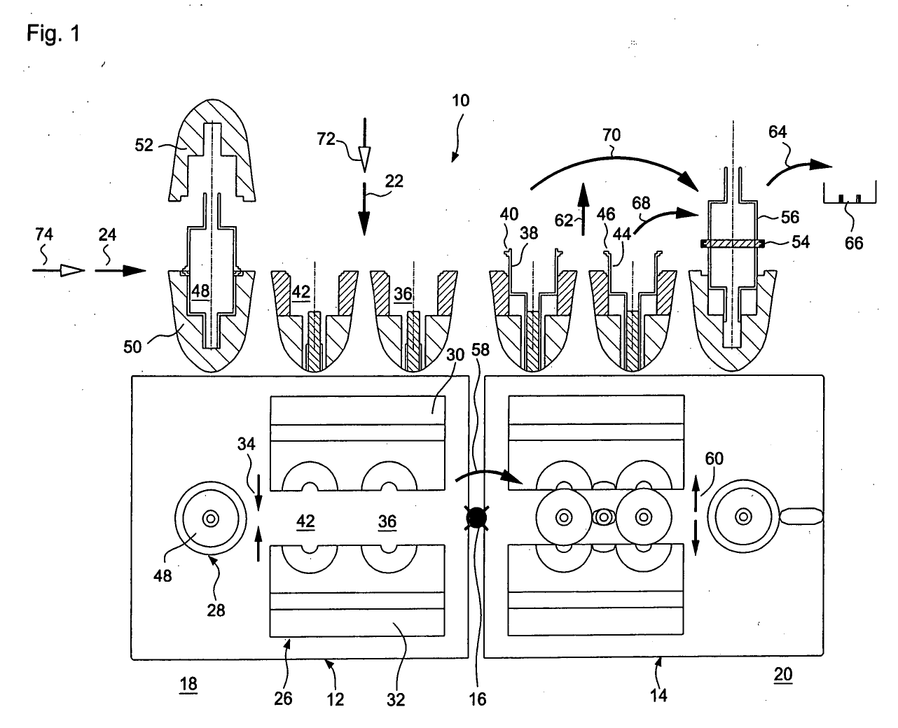

In FIG. 1, an apparatus 10 of the invention is shown in sketchlike form; it includes a first injection molding tool 12 and a second injection molding tool 14. The injection molding tools 12 and 14 are disposed diametrically opposite one another on a turntable, of which the pivot shaft 16 is shown.

The turntable has a injection molding side 18 and a diametrically opposed service side 20; during the operation of the apparatus 10, one of the injection molding tools 12 and 14 is located on each side in alternation.

A first injection molding device 22, represented by an arrow, and a second injection molding device 24, represented in the same way, are located on the injection molding side 18 of the turntable, or of the apparatus 10. The first and second injection molding devices 22 and 24 individually feed a first and a second component of thermoplastics into a first injection mold 26 and a second injection mold 28, respectively. The first injection mold 26 is formed with a first and a second injection mold half 30 and 32, respectively, which can be moved toward one another in a closing direction 34.

With the first and second injection mold halves 30 and 32 thus closed, a first mold 36 is now embodied, in which with the aid of the first injection molding device 22, a first hollow body part 38 can be injection molded. In the operating state shown for the apparatus 10, this first hollow body part 38 is designed with a first joining edge 40 in the injection molding process and has already been moved across to the service side 20.

In a second mold 42, which is likewise formed by the first and second injection mold halves 30 and 32, a second hollow body part 44 with a second joining edge 46 is also injection molded simultaneously during the injection molding of the first hollow body part 28. This second hollow body part 44, in the operating state shown for the apparatus 10, has also already been moved across to the service side 20.

Also embodied in the first injection mold 26 and the second injection mold 28 is a third mold 48, with a lower mold portion 50. An upper mold portion 52 can be placed on top of this lower mold portion 50. With the aid of the second injection molding device 24, a sealing portion 54 can then be injection molded onto a first hollow body part 38 and a second hollow body part 44 that are placed in the third mold 48. By means of this sealing portion 54, the two hollow body parts 38 and 44 are connected to form a complete, closed hollow body 56.

The hollow body 56 produced in this way is moved to the service side 20, where it is shown in FIG. 1, by means of a rotary motion 58 of the turntable about the pivot shaft 16 and the attendant motion of the first and second injection molds 26 and 38.

On the service side 20, the first and second injection mold halves 30 and 32 are first moved apart from one another in an opening direction 60, and then the first hollow body part 38, the second hollow body part 44, and the hollow body 56 are moved slightly in a lifting out direction 62. The hollow body 56 thus lifted out is then inverted, manually or with the aid of a robot arm by means of a removal motion 64, into a tightness testing device 66 that is shown only very schematically. After that, with a first inversion motion 68 and a second inversion motion 70, the first hollow body part 38 and the second hollow body part 44 are inverted onto the lower mold portion 50 of the third mold 48. In this process, first the second hollow body part 44 and then the first hollow body part 38 are inserted, and then the first hollow body part 38 is placed with its first joining edge 40 onto the second joining edge 46 of the second hollow body part 44.

During the removal of the hollow body 56 and the inversion of the hollow body parts 38 and 44, new first and second hollow body parts 38 and 44 and a new hollow body 56 with its sealing portion 54 are injection molded in the second injection molding tool 43, rotated toward the injection molding side 18, in the manner described above, with the aid of the first injection molding device 22 and the second injection molding device 24.

By means of this parallel injection molding during the inversion and removal operations, especially short cycle times can be achieved with the apparatus 10 of the invention. Furthermore, no additional mounting devices or separate joining devices are needed for prepositioning and connecting the two hollow body parts 38 and 44.

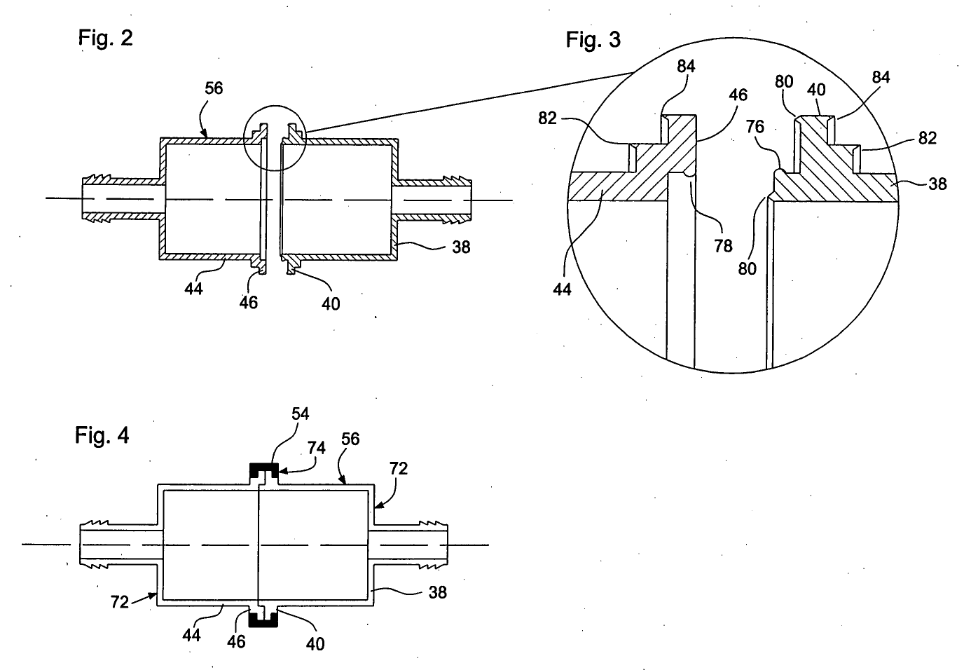

In FIGS. 2-4, a hollow body 56 produced in this way is shown in further detail, with its first hollow body part 38, its second hollow body part 44, and the first and second joining edges 40 and 46, respectively, embodied on the hollow body parts according to the invention, and with the sealing portion 54 spray-coated according to the invention.

Different thermoplastics have been processed in the first and second injection molding devices 22 and 24 of the apparatus 10, so that the two hollow body parts 38 and 44 are produced from a first thermoplastic component 72, while the sealing portion 54 is produced from a second thermoplastic component 74. The various thermoplastics are adapted to the various functions of the components, so that the two hollow body parts 38 and 44 serve as weather-resistant housing halves, in particular over a long service life, while with the sealing portion 54, these housing halves are connected and sealed especially durably.

A radially outward-oriented detent lug 76 and a radially inward-oriented detent lug 78, the orientation being relative to the substantially cylindrical hollow body parts 38 and 44, are embodied on the first joining edge 40 and the second joining edge 46, respectively. During the inversion and prepositioning of the first hollow body part 38 on the second hollow body part 44, the detent lugs 76 and 78 deform elastically and hook on each other from behind and as a result hold the first hollow body part 38 on the second hollow body part 44 by positive engagement and possibly also nonpositive engagement.

On the joining edge 40 of the first hollow body part 38, two sealing edges 80 are also embodied, which protrude axially from the joining edge 40 and taper to a point. These sealing edges 80 are pressed against the joining edge 46 of the second hollow body part 44 as the first hollow body part 38 is being placed and prepositioned on this second hollow body part 44, and as a result the first and second hollow body parts 38 and 44 are each sealed off on the inside and outside at the respective joining edges 40 and 46, and any penetration of thermoplastic into the interior of the hollow body 56 during the spray-coating of the sealing portion 54 is reliably prevented.

A second sealing edge 82, oriented essentially axially outward, is also provided on the outside of each of the two joining edges 40 and 46. These second sealing edges 82 are each deformed elastically-plastically by between 0.1 mm and 0.3 mm each during the aforementioned closure of the lower and upper mold portions 50 and 52, and as a result the joining edges 40 and 46 are sealed off from the associated mold portions 50 and 52, respectively, and an escape of thermoplastic during the injection molding of the sealing portion 54 is reliably prevented.

On the radially outer ends of each of the joining edges 40 and 46, an encircling, essentially axially oriented fusion edge 84 is also provided, each fusion edge being designed such that it is partly converted to the molten state during the spray-coating of the sealing portion 54, thus bringing about a material-engagement connection between the joining edges 40 and 46 and the sealing portion 54.

The joining edges 40 and 46 are also designed with a stairstep cross section, and during the injection molding of the sealing portion 54 they are embraced by the sealing portion in U-shaped fashion and partly enclosed. The thus-formed sealing portion 54 of U-shaped cross section acts like a clamp on the two joining edges 40 and 46. The action of the clamp is reinforced by shrinkage of the thermoplastic of the sealing portion 54 as it cools down after the injection molding, so that the two hollow body parts 38 and 44 are especially advantageously pressed together at their joining edges 40 and 46.

As a result of this pressing together, the sealing action of the first sealing edges 80 is further improved. The hollow body 56 thus sealed off is especially resistant to the penetration of moisture or dirt. Moreover, the connection of the two hollow body parts 38 and 44 made by the sealing portion 54 is durably sealed off even in the event of recrystallization of the plastic components used.

In closing, it should be noted that all the characteristics, either individually or in arbitrary combination, recited in the application and especially in the dependent claims are meant to have independent patent protection, despite the formal dependency on one or more specified claims.

### LIST OF REFERENCE NUMERALS

10 Apparatus
12 First injection molding tool
14 Second injection molding tool
16 Pivot shaft of the turntable
18 Injection molding side
20 Service side
22 First injection molding device
24 Second injection molding device
26 First injection mold
28 Second injection mold
30 First injection mold half
32 Second injection mold half
34 Closing direction
36 First mold
38 First hollow body part
40 First joining edge
42 Second mold
44 Second hollow body part
46 Second joining edge
48 Third mold
50 Lower mold portion
52 Upper mold portion
54 Sealing portion
56 Hollow body
58 Rotary motion
60 Opening direction
62 Lifting out direction
64 Removal motion
66 Tightness testing device
68 First inversion motion
70 Second inversion motion
72 First thermoplastic component
74 Second thermoplastic component
76 First detent lug
78 Second detent lug
80 First sealing edge
82 Second sealing edge
84 Fusion edge

1-10. (canceled)

11. A method for producing a hollow body of thermoplastic, the method comprising the following steps:
injection molding a first hollow body part with an outward-protruding first joining edge;
injection molding at least a second hollow body part with an outward-protruding second joining edge;
putting the hollow body parts together at the first and second joining edges; and
connecting the first and the at least one second hollow body part by molding an at least partially U-shaped sealing portion encompassing the two joining edges, the sealing portion comprising a thermoplastic.

12. The method as defined by claim 11, further comprising mounting at least one component in at least one of the hollow body parts before the hollow body parts are put together.

13. The method as defined by claim 12, wherein the step of mounting the at least one component is performed parallel to an injection molding work step, in particular in a combined injection molding and mounting device.

14. The method as defined by claim 11, wherein the injection molding of the at least two hollow body parts is performed with a first thermoplastic component, and the connecting of the hollow body parts is performed by molding with a second thermoplastic component.

15. The method as defined by claim 12, wherein the injection molding of the at least two hollow body parts is performed with a first thermoplastic component, and the connecting of the hollow body parts is performed by molding with a second thermoplastic component.

16. The method as defined by claim 13, wherein the injection molding of the at least two hollow body parts is performed with a first thermoplastic component, and the connecting of the hollow body parts is performed by molding with a second thermoplastic component.

17. An apparatus for producing a hollow body of thermoplastic with at least one component inserted into it, the apparatus comprising
a first injection molding device integrated with the apparatus for injection molding at least two hollow body parts;
a mounting device integrated with the apparatus for mounting the at least one component in at least one of the hollow body parts and for putting the hollow body parts together at joining edges; and
a second injection molding device, integrated with the apparatus, for connecting the hollow body parts by injection molding of a thermoplastic at the joining edges.

18. The apparatus as defined by claim 17, further comprising a tightness testing device, integrated with the apparatus, for testing the tightness of the hollow body.

19. A hollow body of thermoplastic, comprising
at least two injection molded, put-together hollow body parts, on each of which an outward-protruding joining edge, is embodied; and
an injection molded sealing portion, which is designed as at least partly U-shaped in cross section and embracing the joining edges.

20. The hollow body as defined by claim 19, wherein the hollow body parts each comprise at least one first connecting element at the joining edges, the first connecting elements being in the form of a detent lug by means of which a nonpositive-and/or positive-engagement connection between the put-together hollow body parts is embodied.

21. The hollow body as defined by claim 19,
the hollow body parts are each comprise at least one sealing element at the joining edges, the sealing elements being in the form of a sealing edge, by means of which the hollow body parts are sealed off from one another and/or from an injection mold during the production of the hollow body.

22. The hollow body as defined by claim 20,
the hollow body parts are each comprise at least one sealing element at the joining edges, the sealing elements being in the form of a sealing edge, by means of which the hollow body parts are sealed off from one another and/or from an injection mold during the production of the hollow body.

23. The hollow body as defined by claim 19, wherein
the hollow body parts are each comprise at least one second connecting element at the joining edges, the second connecting elements being in the form of fusion edges by means of which fusion edge or edges a material-engagement connection between the put-together hollow body parts is embodied.

24. The hollow body as defined by claim 20, wherein
the hollow body parts are each comprise at least one second connecting element at the joining edges, the second connecting elements being in the form of fusion edges by means of which fusion edge or edges a material-engagement connection between the put-together hollow body parts is embodied.

25. The hollow body as defined by claim 21, wherein
the hollow body parts are each comprise at least one second connecting element at the joining edges, the second connecting elements being in the form of fusion edges by means of which fusion edge or edges a material-engagement connection between the put-together hollow body parts is embodied.

26. The hollow body as defined by claim 22, wherein
the hollow body parts are each comprise at least one second connecting element at the joining edges, the second connecting elements being in the form of fusion edges by means of which fusion edge or edges a material-engagement connection between the put-together hollow body parts is embodied.
